(19) United States
(12) Patent Application Publication
(10) Pub. No.: US 2015/0068836 A1
(43) Pub. Date: Mar. 12, 2015

(54) Acoustic Core Which Can Be Built Into A Structure

(71) Applicant: GESTION SOPREMA CANADA INC., Drummondville, Quebec (CA)

(72) Inventor: Yvon Duhamel, Drummondville (CA)

(21) Appl. No.: 14/391,627

(22) PCT Filed: Mar. 7, 2013
(86) PCT No.: PCT/CA2013/050168

§ 371 Date: Oct. 9, 2014

(30) Foreign Application Priority Data
Jun. 12, 2012 (CA) 2,780,416

(51) Int. Cl. G10K 11/168

(52) U.S. Cl. CPC G10K 11/168
USPC 181/290

(57) ABSTRACT

An acoustic core which can be built into a structure, such as a door or partition, in order to enable the structure to have good sound absorption and/or sound insulation properties. The core includes a multilayer substrate which has a soundproofing effect and which is mounted between two outer parts, the multilayer substrate and the outer parts being attached together so as to form a whole. The multilayer substrate includes an upper layer consisting of a polymer film, a central layer consisting of a polymeric and/or oxidized bitumen optionally having a reinforcement, and a lower layer consisting of aggregate from recycled tires. The outer parts are made of wood, wood derivatives, metal, or a plastic material, and are each provided with grooves or wedges in order to prevent full surface contact with the multilayer substrate and thereby enhance the desired soundproofing effect.

### FIELD OF THE INVENTION

The present invention relates to an acoustic core which can be built into a structure, in order to enable said structure to have good sound absorption and/or sound insulation properties.

### BACKGROUND OF THE INVENTION

Within the scope of the present invention, the word “structure” refers to a door made out of wood or metal, a partition, a fence, or any other element in which an acoustic core of the present invention could be incorporated in order to obtain a high soundproofing performance.

The acoustic core according to the invention is characterized in that it comprises a multilayered substrate with soundproofing qualities, sandwiched between two external pieces. The ensemble, including the multilayered substrate and the external pieces secured to one another, form the said core.

The multilayered substrate used in the scope of the present invention is similar to the one described in the Canadian patent application No. 2,623,095 filed in the name of the applicant, with designation of the same inventor.

### SUMMARY OF THE INVENTION

This multilayered substrate comprises:

a top layer consisting of a polymer film

a middle layer consisting of a polymer bitumen and/or oxidized optionally with an inner fibreglass-based and/or polyester-based reinforcement, the said middle layer being optionally covered on each side of the bitumen with a thermofusible or silicon film; and

a bottom layer consisting of granules of recycled tires which are applied on an additional support of bitumine polymer, or located directly on the middle layer.

Preferably, in the bottom layer of the acoustic substrate, the granules have a diameter between 0.85 and 12 mm (30 to 2 mesh).

Preferably also, in the multilayered substrate:

the top layer consists of a polyester film having a thickness between 0.8 and 1.2 mm, or a high-density polyethylene film having a thickness between 75 and 150 microns (3 to 6 mils);

the middle layer has a thickness between 2.2 and 4.8 mm; and

the bottom layer has a thickness between 3 and 20 mm.

Regarding the external pieces, they are made of wood, wood derivatives such as MDF or HDF, plywood, pressed wood, metal or plastic. These pieces are each provided with grooves or wedges to avoid a full contact with the surface of the multilayered substrate in order to increase the desired soundproofing effect.

It is worth noting that the essential difference between the present invention and that which is described in Canadian application No. 2,623,095, is the presence of external pieces which are used and attached directly to the multilayered substrate in order to form the acoustic core which can be built into a structure. Indeed, in Canadian application No. 2.623.095, the multilayered substrate is essentially intended to be installed in a floor covering, in particular a wood floor, in order to soundproof the floor. So, such it is not an assemblage of elements forming a core and the use is different.

### BRIEF DESCRIPTION OF THE DRAWINGS

The present invention and its advantages will become more apparent in the following description which makes references to the attached drawings in which:

FIGS. 1 and 1a are perspective views of an acoustic core according to the invention where the external pieces are provided with grooves made therein;

FIGS. 2 and 2a are perspective views of an acoustic core according to the invention where the external pieces are provided with wedges;

FIG. 3 is a cross-section view of an acoustic core according to the invention where the multilayered substrate and the external pieces are attached to one another by an adhesive;

FIG. 4 is a cross-section view of an acoustic core according to the invention where the multilayered substrate and the external pieces are attached to one another by screws; and

FIG. 5 is a detailed cross-section view of a portion of a door equipped with an acoustic core according to the present invention.

### DETAILED DESCRIPTION OF THE INVENTION

As is illustrated in the Figures of the attached drawings, the acoustic core 1 according to the invention comprises a soundproofing multilayered substrate 2 which is sandwiched between two external pieces 3 which can be made out of wood, wood derivatives, metal or plastic.

The multilayered substrate 2 which is used is similar to that which is described in the aforementioned Canadian patent application No. 2,623,095.

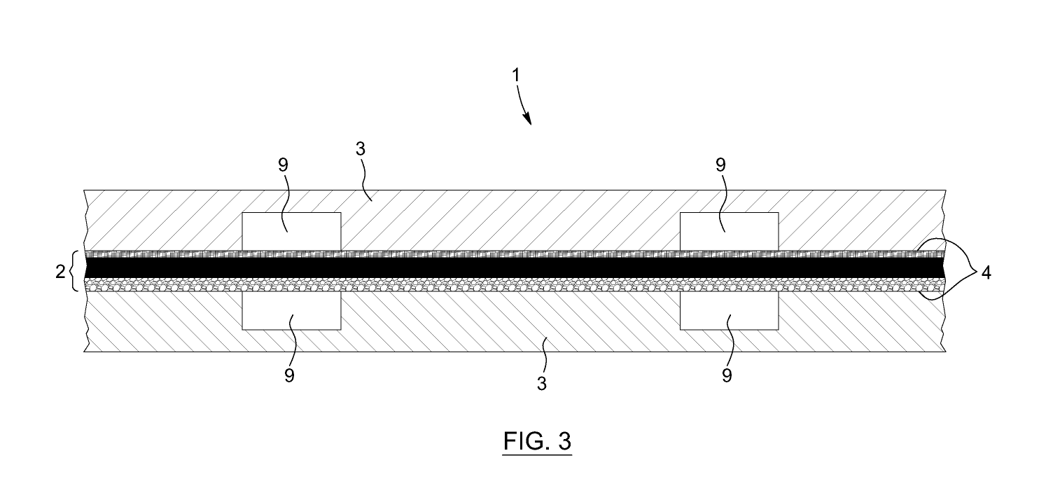

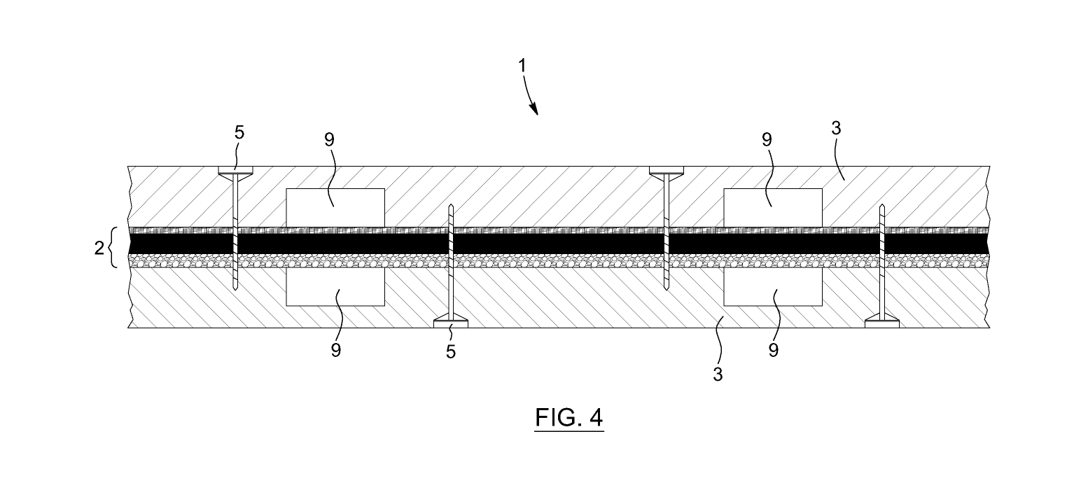

As is illustrated in FIG. 3, the multilayered substrate 2 and the external pieces 3 are attached by means of adhesive layers 4, such as glue, to form said core 1. Alternatively, the multilayered substrate 2 and the external pieces 3 can be attached together by means of screws 5, as is illustrated in FIG. 4.

As mentioned above, the essential purpose of the acoustic core according to the invention is to provide an element which can be integrated into a structure in order to enable said structure to have good sound absorption and/or sound insulation properties. Such a structure that is to be improved, can be a door made out of wood or metal, a partition, or any other element in which the acoustic core of the present invention could be incorporated in order to obtain a high soundproofing performance. Of course, it will be understood that the thickness of the pieces 3 may vary according to the needs of the intended use.

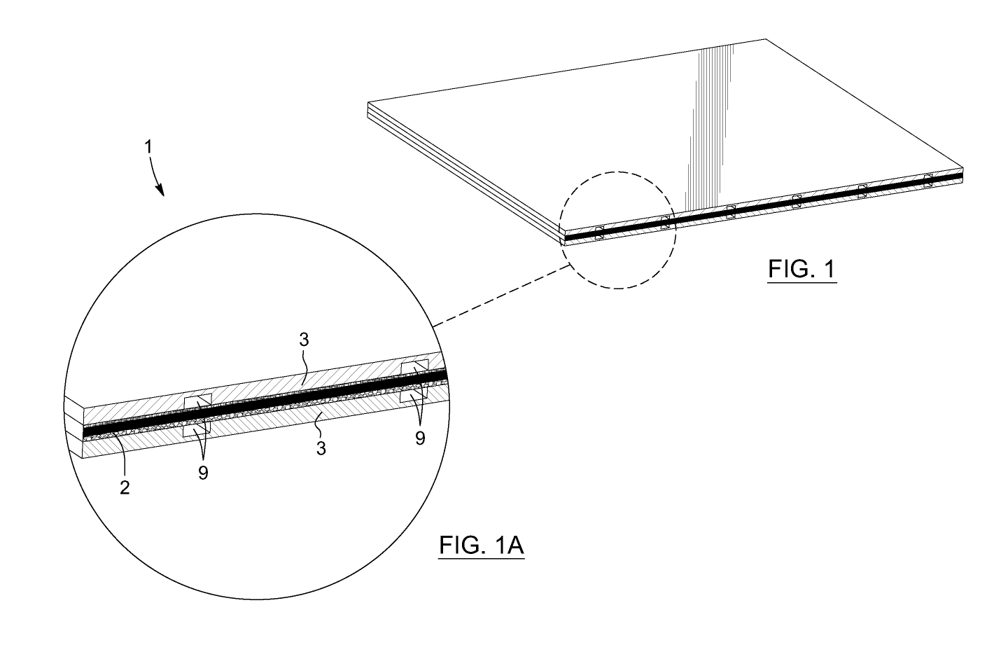

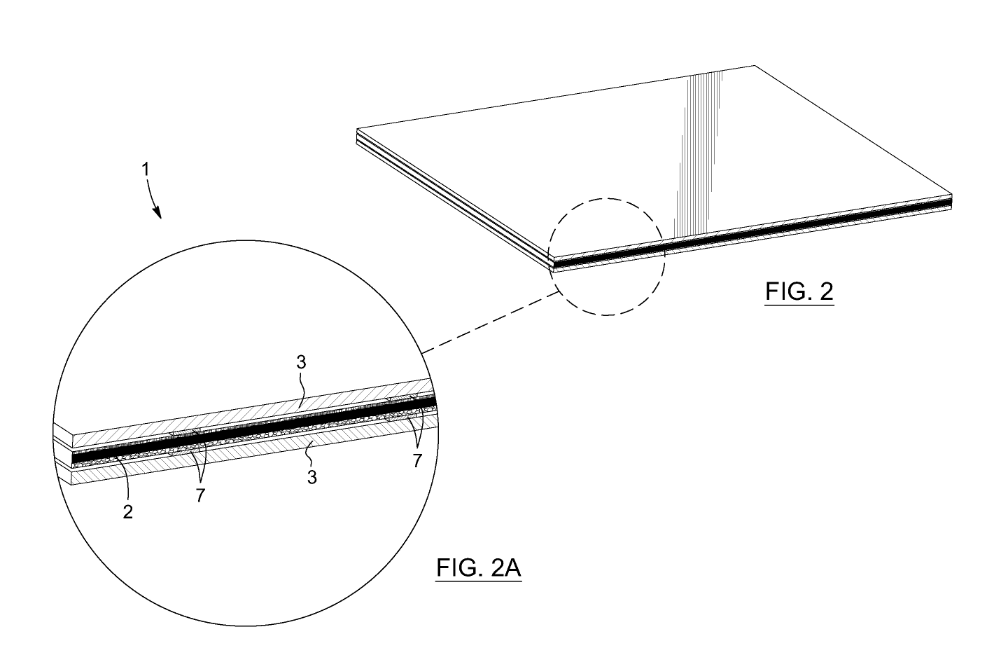

In order to obtain an optimal acoustic performance, the acoustic core 1 according to the invention is constructed in such a way that its multilayered substrate 2 is placed so as to be in partial independence with the external pieces 3. This partial independence can be obtained by making grooves 9 in each of the pieces 3, as is illustrated in FIG. 1, to avoid 100% of contact with the multilayered substrate 2. Alternatively, this partial independence can be obtained with the aid of wedges 7 which can be inserted between the multilayered substrate 2 and the pieces 3, as illustrated in FIG. 2.

Here again, it will be understood that the depth of the grooves carved in the pieces or the thickness of the wedges used to create the desired partial dependence can vary in dimension and in spacing from one another, based on the required needs.

The acoustic core according to the invention is preferably shaped in the form of a panel which could have dimensions of about, for example, 120 to 250 cm (48″×96″). Of course, this panel may have other dimensions and its forms could vary according to different needs, notably with respect to the space in which the acoustic core is intended to be incorporated within a given structure.

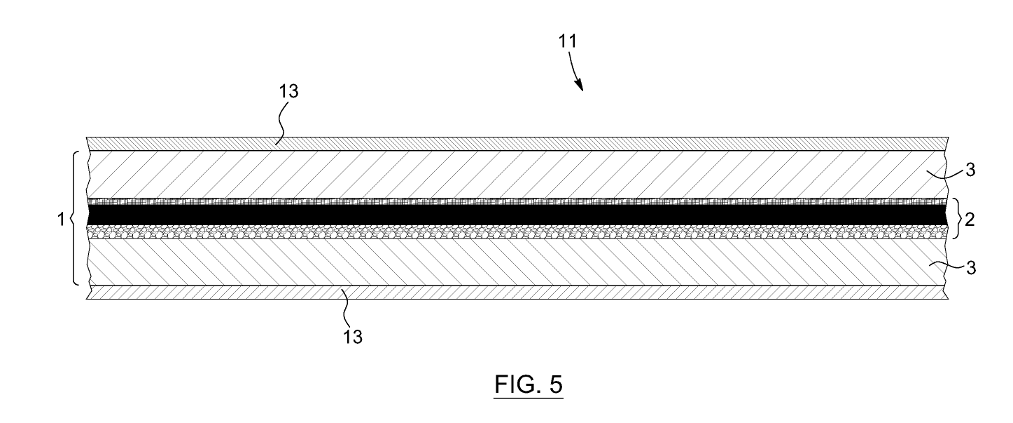

FIG. 5 illustrates a test conducted within the scope of the present invention and is described hereafter for exemplary purposes.

### EXAMPLE

The test was carried out on a door treated with an acoustic core according to the invention, comprising of a multilayered substrate 2 inserted in-between two pieces of plywood of 9/16″ 3. The assembly of the plywood pieces with the multilayered substrate 2 was done with the aid of an adhesive, without any grooves or wedges.

The acoustic core 1 formed as such was inserted into a door assembly 11 which was comprising a layer of MDF 13 of ⅛″ on either side of the acoustic core 1.

The layers of MDF 13 were assembled on the acoustic core 1 also with the help of an adhesive. The acoustic door 11 formed as such had a total thickness of 1¾″ and its dimensions were 32″×80″.

This acoustic door 11 was installed inside a doorframe on an actual construction site in order to measure its acoustic performance in the form of the FSTC indicator (Field Sound Transmission Class).

The FSTC acoustic indicator was measured at 43. For information purpose, a standard wooden door with a hollow core has an FSTC indicator of about 15, while a standard wooden door with a solid core has an FSTC indicator of about 38.

The difference of 15 points (43 versus 28) represents an enormous improvement, since every increase of 3 points represents a doubling in acoustic performance. Furthermore, this improvement was obtained even without the use of grooves or wedges in the external pieces.

Of course, other modifications could be made to the invention as described hereinabove without departing from the scope of the present invention.

1. An acoustic core which can be built into a structure in order to enable the structure to have good sound absorption and/or sound insulation properties, said core being characterized in that it comprises a multilayered substrate for soundproofing, sandwiched between two external pieces, said multilayered substrate and the external pieces being attached to one another to form the said core,
said multilayered substrate comprising:
a top layer comprising a polymer film;
a middle layer comprising a polymer bitumen and/or oxidized optionally with an inner fibreglass-based and/or polyester-based reinforcement, said middle layer being optionally covered on each side of the bitumen with a thermofusible or silicon film; and
a bottom layer comprising granules of recycled tires which are applied on an additional support of bitumine polymer or located directly on the middle layer.
said external pieces being made of wood, wood derivatives, metal or plastic and being each provided with grooves or wedges for avoiding a total contact surface with the multilayered substrate, therefore increasing the desired soundproofing effect.

2. The acoustic core according to claim 1, characterized in that the multilayered substrate and the external pieces are attached to each other by means of an adhesive.

3. The acoustic core according to claim 1, characterized in that the multilayered substrate and the external pieces are attached to each other by means of a screw.

4. The acoustic core according to claim 1, characterized in that the external pieces are each made from a single material in which the grooves are formed.

5. The acoustic core according to claim 1, characterized in that the external pieces are each made from a material on which wedges are attached in order to form spaces during assembly of the core.

6. The acoustic core according to claim 1, characterized in that it is in the form of a panel.

7. The acoustic core according to claim 6, characterized in that the panel has a surface of about 120 cm to about 250 cm.

8. The acoustic core according to claim 1, characterized in that, in the bottom layer of the acoustic substrate, the granules have a diameter ranging between about 0.85 mm and about 12 mm.

9. The acoustic core according to claim 1, characterized in that, in the multilayered substrate:
the top layer comprises a polyester film having a thickness ranging between about 0.8 mm and about 1.2 mm or a high-density polyethylene film having a thickness ranging between about 75 microns and about 150 microns;
the middle layer has a thickness ranging between about 2.2 mm and about 2.8 mm; and
the bottom layer has a thickness ranging between about 3 mm and about 20 mm.

10. The use of an acoustic core according to claim 1 in a structure of a door made out of wood or metal, a partition or a fence, in order to give to the structure a high soundproofing performance.

11. The acoustic core according to claim 2, characterized in that it is in the form of a panel and the external pieces are each made from a material on which wedges are attached in order to form spaces during assembly of the core.

12. The acoustic core according to claim 11, characterized in that, in the multilayered substrate:
the top layer comprises a polyester film having a thickness ranging between about 0.8 mm and about 1.2 mm or a high-density polyethylene film having a thickness ranging between about 75 microns and about 150 microns;
the middle layer has a thickness ranging between about 2.2 mm and about 2.8 mm; and
the bottom layer has a thickness ranging between about 3 mm and about 20 mm.

13. The acoustic core according to claim 3, characterized in that it is in the form of a panel and the external pieces are each made from a material on which wedges are attached in order to form spaces during assembly of the core.

14. The acoustic core according to claim 13, characterized in that, in the multilayered substrate:
the top layer comprises a polyester film having a thickness ranging between about 0.8 mm and about 1.2 mm or a high-density polyethylene film having a thickness ranging between about 75 microns and about 150 microns;
the middle layer has a thickness ranging between about 2.2 mm and about 2.8 mm; and
the bottom layer has a thickness ranging between about 3 mm and about 20 mm.
